(19) United States
(12) Patent Application Publication
(10) Pub. No.: US 2017/0251872 A1
(43) Pub. Date: Sep. 7, 2017

(54) ELECTRIC ROASTING OVEN HAVING A DOMED LID AND METHOD OF USE

(71) Applicants: George T.C. Li, Reno, NV (US); Eric Li, Reno, NV (US)

(72) Inventors: George T.C. Li, Reno, NV (US); Eric Li, Reno, NV (US)

(21) Appl. No.: 15/058,297

(22) Filed: Mar. 2, 2016

(51) Int. Cl. A47J 37/06; A23L 5/10

(52) U.S. Cl. CPC A47J 37/0629; A23L 5/15; A47J 37/0664

(57) ABSTRACT

An electric roasting oven and method of use are disclosed. The roasting oven can comprise, in various embodiments, a double walled dome lid that includes an inner wall lid and an outer wall lid, wherein the inner wall lid and outer wall lid are joined at a base of the double walled dome lid, a shallow pan that interfaces with the base of the double walled dome lid, and a temperature controlling component disposed in the double walled dome lid. The temperature controlling component can include a heating element that is electrically coupled to the temperature controlling component, and the heating element can be radially disposed about an exterior surface of the inner wall lid and within the outer wall lid.

### FIELD

The present disclosure relates to an electric roasting system and method. More particularly, the present disclosure relates to an electric roasting oven having a dome shaped lid that includes a heating element disposed within the dome shaped lid.

### BACKGROUND

A variety of stand-alone roasting ovens have been developed to roast different food products (e.g., turkey, chicken, and the like) without the use of a conventional kitchen oven. These stand-alone roasting ovens are also referred to as “roaster ovens” or “roasters.”

Roaster ovens offer a variety of conveniences including being an energy-efficient alternative to turning on the full-size oven. Roaster ovens also provide an extra cooking space during the holidays. Also, roaster ovens are also easier to clean because the roaster pan is dishwasher safe. Additionally, the preparation of gravy is simplified with the roaster oven because the gravy can be easily simmered in the roaster oven pan. Roaster ovens can also be used for baking, cooking and serving. The roaster oven also includes a secure-fitting lid that helps trap in heat and moisture. When the lid is removed, the roaster provides convenient access to stir or transfer food to an individual bowl or plate. Generally, the roaster oven also includes a removable rack to easily transport large roasts or turkeys to a serving platter.

Typical roasters include a wrap-around type heating element for applying heat to the sides of the cooking vessel or, alternatively, a bottom heating element arranged in functional relation to the bottom of the cooking well for supplying heat for cooking. Such cooking wells are often constructed of aluminum, stainless steel or enameled steel for reasons of durability and sanitation. However, it is known that both stainless steel and enameled steel have relatively low coefficients of heat conductivity as compared with other metals. This presents a particular problem for cooking vessels of large capacity (i.e. up to 26 quarts). Applying heat only to the bottom or sides of such a large capacity cooking vessel, especially when constructed of stainless steel or enameled steel, can result in the upper portion of the cooking vessel being insufficiently heated. Thus, the food in the upper portion of the cooking vessel may be insufficiently cooked for serving purposes due to the loss of heat in combination with the low rate of heat conductivity and the slow rate at which heat is supplied to the upper portion of the cooking vessel. Often such a cooking vessel lacks top-browning (i.e. to scorch lightly) capability, which is desirable when cooking chicken, turkey or other foodstuffs.

Traditional roasters are unable to effectively brown the top of large birds such as an illustrative turkey, which results in a “white spot” on the top of the large bird. To effectively remove the white spot, the illustrative turkey is removed from the roaster oven and put into a regular over for roasting. This two-step process creates additional work and clean-up and the extra step of cooking in a traditional oven causes the illustrative turkey to lose its moisture and tenderness. Basically, a properly browned turkey that is exposed to the two-step process of using a roasting oven and then a kitchen oven is dry and unappetizing.

Thus, a roasting oven capable of easily and uniformly roasting and browning a top surface of a particular food product is desirable.

### SUMMARY

A roasting oven and method of use are described. The roasting oven includes a double walled dome lid, a shallow pan and a temperature controlling component. The double walled dome lid includes an inner wall lid and an outer wall lid. The inner wall lid and the outer wall lid are joined at a base of the double walled dome lid. A shallow pan interfaces with the base of the double walled dome lid. The temperature controlling component is disposed in the double walled dome lid and a heating element that is electrically coupled to the temperature controlling component. The heating element is radially disposed about an exterior surface of the inner wall lid and within the outer wall lid.

In one illustrative embodiment, the double walled dome lid includes a fixed leg that enabled the double walled dome lid to stand when the double walled dome lid is vertically positioned. In another embodiment, the double walled dome lid includes a fold out leg that enables the double walled dome lid to stand when the double walled dome lid is vertically positioned. In yet another illustrative embodiment, the double walled dome lid includes a fixed leg and a fold-out leg that enables the double walled dome lid to stand when the double walled dome lid is vertically positioned.

In a further embodiment, the heating element includes a heating belt and an insulating material radially disposed about said heating element and positioned within the outer wall lid, wherein a top of the double walled dome does not include insulating materials. In a still further embodiment, the heating element includes a heating belt and an insulating material that is disposed between the inner wall lid and the outer wall lid. In yet another embodiment, the temperature controlling component includes a thermostat or a thermocouple.

An oven system is also described. The oven system includes a double walled dome lid, a shallow a pan, a tray and a temperature controlling component. The double walled dome lid that includes an inner wall lid and an outer wall lid. The inner wall lid and outer wall lid are joined at a base of the double walled dome lid. The shallow pan interfaces with the base of the double walled dome lid and forms a chamber. The tray sits on the shallow pan and receives a food product. The temperature controlling component is disposed in the double walled dome lid. The temperature controlling component includes a heating element that is electrically coupled to the temperature controlling component. The heating element is radially disposed about an exterior surface of the inner wall lid and the heating element positioned within the outer wall lid. The temperature controlling component receives a cooking input that causes the heating element to heat the chamber so that the food product is uniformly browned.

A method for cooking with a roasting oven is described. The method includes receiving a food product in a tray that sits on a shallow pan. The shallow pan is then covered with a double walled dome lid that includes an inner wall lid and an outer wall lid. The inner wall lid and outer wall lid are joined at a base of the double walled dome lid, in which the base interfaces with the shallow pan to form a chamber. The method then proceeds to receive a cooking input at a temperature controlling component that is disposed within the double walled dome lid. The temperature controlling component includes a heating element that is electrically coupled to the temperature controlling component. The heating element is radially disposed about an exterior surface of the inner wall lid and the heating element positioned within the outer wall lid. The heating element heats the chamber so that the food product is uniformly browned.

### FIGURES

The present invention will be more fully understood by reference to the following drawings which are presented for illustrative, not limiting, purposes.

FIG. 1 shows a perspective view of a roasting oven as disclosed herein and in accordance with various embodiments.

FIG. 2 shows a perspective view of an exterior portion of the dome lid of the roasting oven as disclosed herein and in accordance with various embodiments.

FIG. 3 shows a perspective view of an interior portion the dome lid of the roasting oven as disclosed herein and in accordance with various embodiments.

FIG. 4 shows a side view of the roasting oven, wherein a power cable is deployed, as disclosed herein and in accordance with various embodiments.

FIG. 5 shows a side view of the roasting oven as disclosed herein, wherein a power cable is stowed about the fixed leg of the dome lid, in accordance with various embodiments.

FIG. 6 shows a back view of the dome lid of the roasting oven as disclosed herein, wherein a fold-out support structure or “leg” is stowed or folded, in accordance with various embodiments.

FIG. 7 shows a side view of the dome lid of the roasting oven resting in a vertical orientation as disclosed herein and in accordance with various embodiments.

FIG. 8 shows a bottom view of the roasting oven as disclosed herein and in accordance with various embodiments.

FIG. 9 shows a top view of the roasting oven, as disclosed herein and in accordance with various embodiments.

FIG. 10 shows an exploded view of the roasting oven as disclosed herein and in accordance with various embodiments.

FIG. 11 shows a partial cross-section of an embodiment of the roasting oven, wherein an insulating material is disposed between the outer wall lid and the heating element, as disclosed herein and in accordance with various embodiments.

FIG. 12 shows a cutout view of the inner wall and outer wall of the dome lid as disclosed herein and in accordance with various embodiments.

FIG. 13 shows an electrical circuit diagram of the roasting oven as disclosed herein and in accordance with various embodiments.

FIG. 14 shows a process for cooking a food product with a roasting oven as disclosed herein and in accordance with various embodiments.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims.

In various embodiments, the roasting oven disclosed herein can include a double walled dome lid, a shallow base pan configured to interface with the dome lid, a heating element radially disposed within the doubled walled dome lid, and a temperature controlling component. The heating element can be enclosed within (or separated from the food product by) an insulator, such as a fiber glass insulator.

The dome lid can further comprise a large and heavy lid configured to retain heat energy. The heating element can be disposed within and about a perimeter of the dome lid and extend from a base of the dome lid to a particular height above the base of the dome lid. The heating element can thus comprise a “belt” that extends within the dome lid about a perimeter thereof. The heating element may not, therefore, be disposed about a top surface of the dome lid.

In operation, the food product can be placed within the base pan and covered by the dome lid to enclose the food product between the base pan and dome lid. The space enclosed between the base pan and dome lid may be referred to herein as a “heating chamber,” or simply a “chamber.” A cooking input can be received at a temperature controlling component disposed within the dome lid, and the heating element can, in response to the cooking input, heat the chamber of the roasting oven based upon the selected cooking input.

The dome lid can retain and distribute heat over the surface of the food product, and in particular, over much of the food product, including the top surface (e.g., in the case of a turkey, over the turkey breast) of the food product. Moreover, because the heating element is disposed within the dome lid, the roasting oven disclosed herein can uniformly roast and/or brown the food product without exposing the food product to direct heat. The food product may not therefore scorch or burn. The inventors' hypothesize that because the dome lid is quite heavy, that the roasting oven is able to develop and maintain an internal pressure that is greater than the air pressure outside of the roasting oven. The roasting oven can therefore operate, to some extent, as a pressure cooker. A food product disposed within the heating chamber can thus brown uniformly as well as retain its juiciness during cooking.

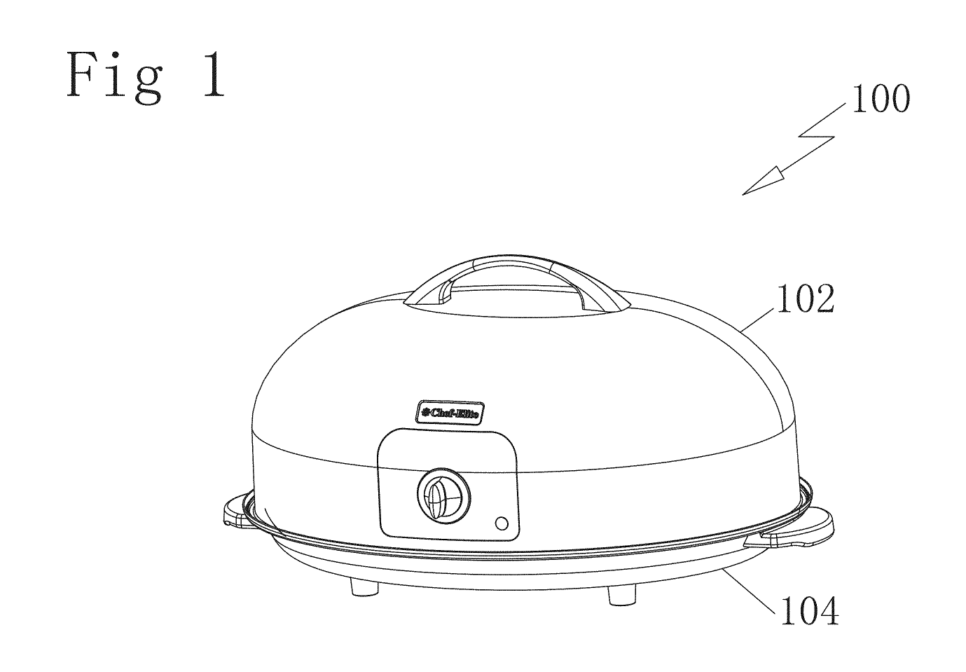

With reference now to FIG. 1, a perspective view of a roasting oven 100 is shown. The roasting oven 100 can generally comprise a dome lid 102 and a tray or base pan 104. The dome lid 102 can interface with the base pan 104 at a base of the dome lid 102 to form a heating chamber. As described herein, a food product to be roasted and/or browned can be placed within the roasting oven 100. In addition, as described in greater detail below, the dome lid 102 can comprise a double walled dome lid. In various embodiments, the dome lid 102 and base pan 104 can comprise any metallic material such as sheet steel, aluminum, and/or chrome, any ceramic or partially ceramic material, any heat resistant glass, any heat resistant plastic, and/or any other suitable material.

The dome lid 102 can, as shown, rest on a relatively shallow base pan 104. Accordingly, the dome lid 102 can cover a majority of the food product within the heating chamber, while the base pan 104 can serve, in various embodiments, primarily to support the food product. The dome lid 102 is therefore large and somewhat heavy, particularly in comparison to the size and weight of the base pan 104. As such, and as described herein, the dome lid 102 is configured to store and radiate heat energy. The heavy dome lid 102 can, in addition, develop and maintain an internal air pressure within the heating chamber and, as a result, a high temperature within the heating chamber. In other words, the roasting oven 100 can function as a pressure cooker, because the dome lid 102 is sufficiently heavy to maintain an internal air pressure without disruption to a seal formed between the dome lid 102 and base pan 104. A food product, such as a turkey, can therefore brown more uniformly over its outer surface (due to the high temperatures maintained within the heating chamber) as well as retain its juiciness and flavor (due to the air pressure developed within the heating chamber).

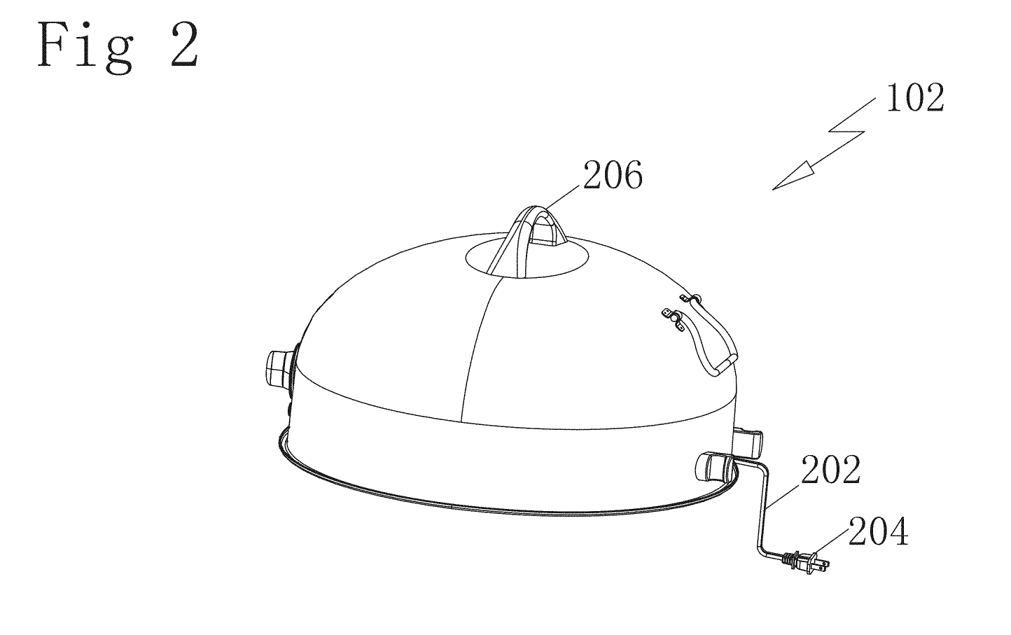

Referring to FIG. 2, a perspective view of an exterior portion of the dome lid 102 is shown. A power cable 202 can extend from the dome lid 102. The power cable 202 can terminate in a plug connector 204, which can be electrically coupled to a standard AC power outlet (e.g., a 120-volt power outlet in North America). The power cable 202 can supply power to the roasting oven 100. The dome lid 102 can further comprise a handle 206. A roasting oven operator can lift the dome lid 102 away from the base pan 104 using the handle 206 to expose the food product disposed within the roasting oven 100 (and/or to place a food product within the roasting oven 100).

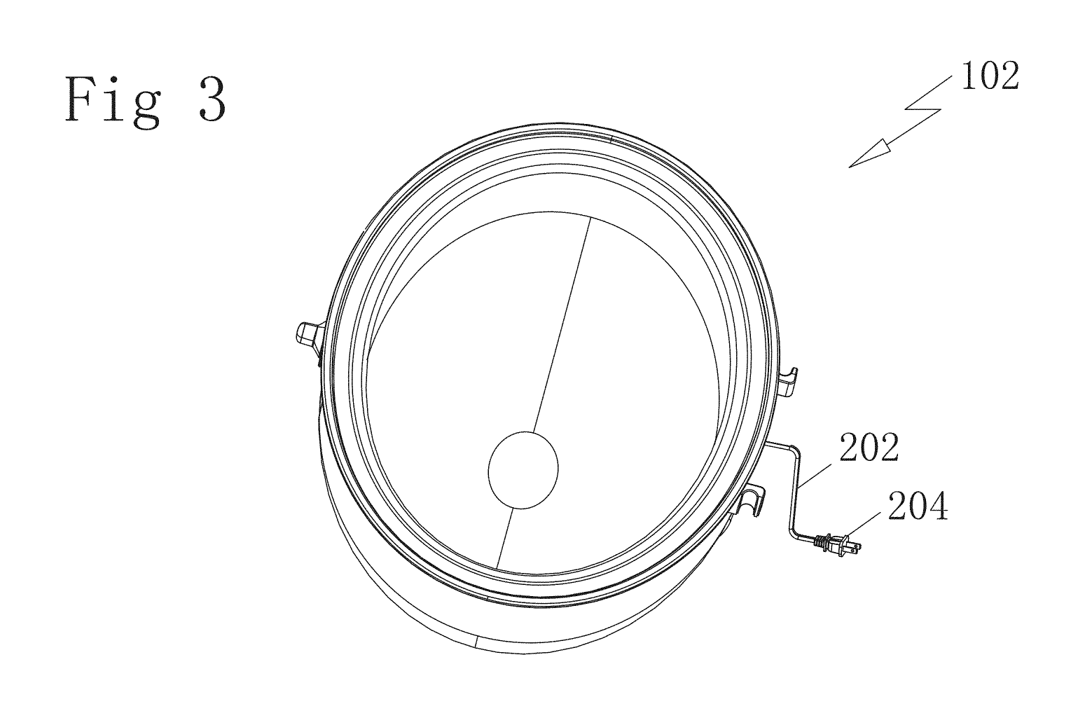

FIG. 3 shows a perspective view of an interior portion the dome lid 102. As shown, the interior portion of the dome lid 102 can rise sharply away from the base pan 104, such that the dome lid 102 defines, together with the base pan 104, the heating chamber (as described herein) within which a food product can be placed for roasting and surface browning. Thus, as described herein, the roasting oven 100 can comprise a very shallow base pan 104 configured to interface with a dome lid 102 that rises from the shallow base pan 104 over the food product to encompass much of the food product. In various embodiments, the base pan 104 can be less than 1.5 inches deep. The dome lid 102 can fit over such a shallow base pan 104 to ensure that the food product is adequately browned and cooked by the heating element (described herein) disposed within the dome lid 102. The roasting oven 100 disclosed herein may therefore be regarded as an “upside down” or inverted version of a conventional roasting oven, in that the base pan 104, which may typically include the heating element, is shallow and merely functions to support the food product, while the dome lid 102 is very deep and functions to heat, brown, and cook the food product.

However, in various embodiments, the base pan 104 can include a heating element for heating pan drippings or trimmings collected within the base pan 104 during roasting. A roasting oven 100 operator can, for example, activate (e.g., via a temperature controlling component of the base pan 104) a heating element disposed within the base pan 104 to bring pan drippings (and/or other food products) to a simmer within the base pan 104. An operator of the roasting oven 100 can therefore, for example, prepare a gravy within the base pan 104.

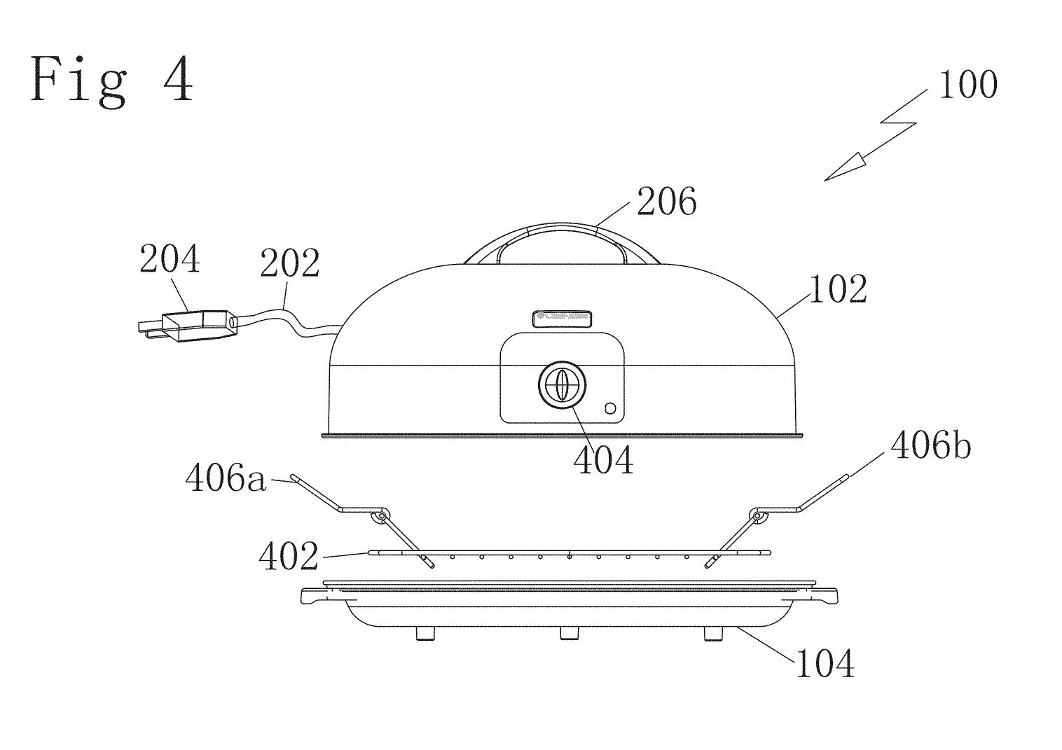

With reference to FIG. 4, a side view of the roasting oven 100, in which the power cable 202 is deployed, is shown. As shown, the roasting oven 100 can include a rack 402 and a temperature controlling component 404. The rack 402 can be seated in the base pan 104, such that a food product placed on the rack 402 is elevated a slight distance above the bottom portion of the base pan 104. In various embodiments, the rack 402 can elevate the food product from between 0.5 inches above the bottom of the base pan 104 to 3.0 inches above the bottom of the base pan 104. The temperature controlling component 404 can be variously disposed within and/or about the roasting oven 100, such as, for example, within the dome lid 102.

In various embodiments, the temperature controlling component 404 can comprise any suitable temperature input and control device, such as, for example, a temperature, brownness, or doneness selector, a thermostat, and/or a thermocouple. A thermostat is an electromechanical component that senses the temperature within the heating chamber of the roasting oven, so that the internal temperature within the roasting oven 100 is maintained at or near a desired set point. The thermostat does this by switching heating or cooling devices on or off. A thermocouple is an electrical device consisting of two different conductors forming electrical junctions at differing temperatures. A thermocouple produces a temperature-dependent voltage as a result of the thermoelectric effect, and this voltage can be interpreted to measure the internal temperature within the roasting oven 100.

An operator of the roasting oven 100 can therefore set the temperature controlling component 404 to a desired temperature, a desired browning effect, a desired doneness (e.g., rare, medium rare, medium, well done, etc.), and the like. Having set the temperature controlling component 404, the temperature controlling component 404 can regulate (e.g., via the thermostat or thermocouple of the temperature controlling component 404) the temperature within the roasting oven 100, as described in greater detail below.

Moreover, in various embodiments, the rack 402 can include a plurality of lifting handles, such as lifting handles 406a and 406b. The lifting handles 406a and 406b can be grasped by a roasting oven 100 operator to lift and/or lower a food product placed on the rack 402 out of and/or into the base pan 104, respectively. Thus, a heavy food product, such as a turkey, can be safely and easily removed form and/or inserted into the base pan 104.

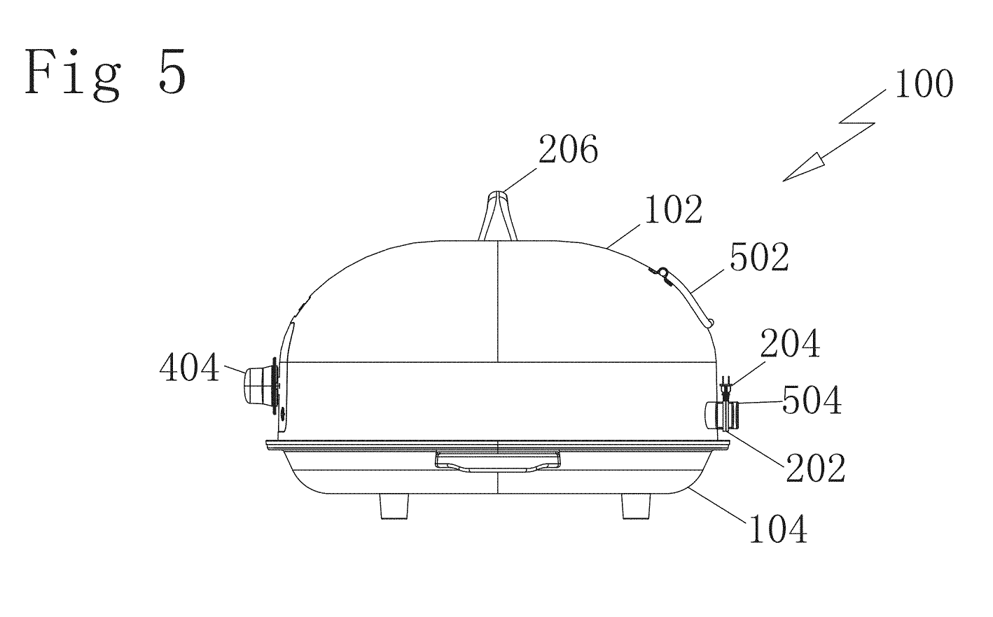

Referring to FIG. 5, a side view of the roasting oven 100 in which the power cable 202 is stowed about the dome lid 102 is shown. Accordingly, in various embodiments, the power cable 202 can be stowed or wound about the dome lid 102 when the roasting oven 100 is not in use. Thus, the power cable 202 can be stowed such that the roasting oven 100 can be easily and compactly stored.

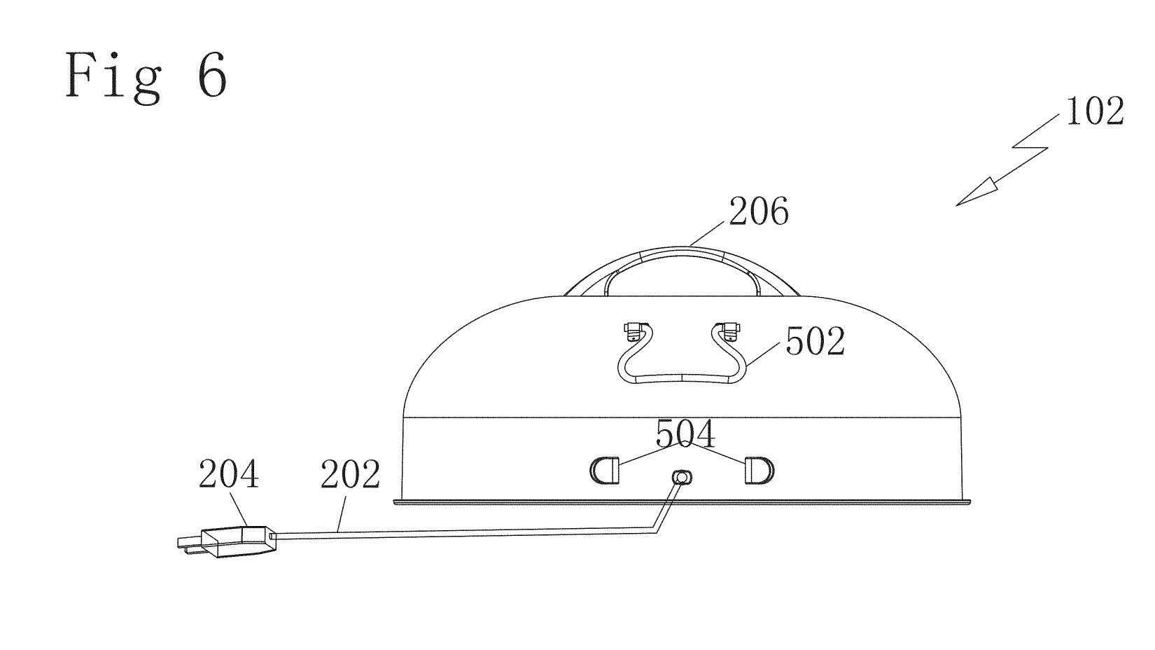

The dome lid 102 can include, in various embodiments, a fold-out support structure or leg 502 as well as a fixed support structure or leg 504. The fold-out leg 502 can be coupled to an exterior surface of the dome lid 102. A fixed support structure or leg 504 can be coupled to the exterior surface of the dome lid 102 as well. When the dome lid 102 is disposed over the base pan 104 (e.g., during a roasting operation), the fold out leg 502 can be folded substantially flat against the exterior surface of the dome lid 102, and the fixed leg 504 can extend, as shown, a short distance away from the exterior surface of the dome lid 102. When the dome lid 102 is removed from the base pan 104 (e.g., when a food product is being exposed within the base pan 104, removed from the base pan 104, or placed within the base pan 104), the fold out leg 502 can be manipulated by the roasting oven 100 operator such that the fold out leg 502 folds out to extend away from the dome lid 102. A side view of the dome lid 102 of the roasting oven 100 in which the fold-out leg is stowed or folded is shown at FIG. 6.

In various embodiments (and as described further below with respect to FIG. 9), the power cable 202 can be wound and stowed about the fixed leg 504. More particularly, the fixed leg 504 can comprise two members (see, e.g., FIG. 9, members 906a and 906b), about which the power cable 202 can be wound and stowed.

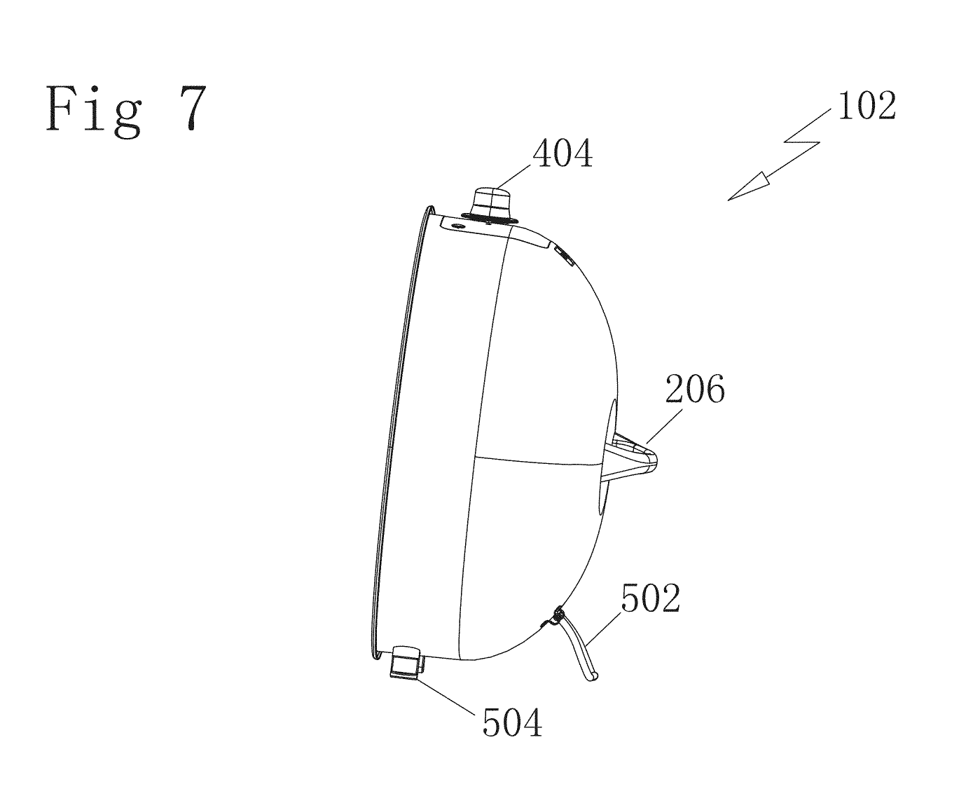

As shown at FIG. 7, the dome lid 102 can be placed by the roasting oven 100 operator in a vertical or standing position. In a vertical position, the dome lid 102 can rest on the fold out leg 502 as well as the fixed leg 504. Moreover, in a vertical position, the dome lid 102, which can become very hot during operation, can be safely and conveniently set aside, so that the roasting oven 100 operator is not burned or otherwise inconvenienced by the dome lid 102. As described above, the dome lid 102 can be somewhat large and heavy. The fold out leg 502 and fixed leg 504 can therefore be sufficiently sturdy to support a large and heavy dome lid 102.

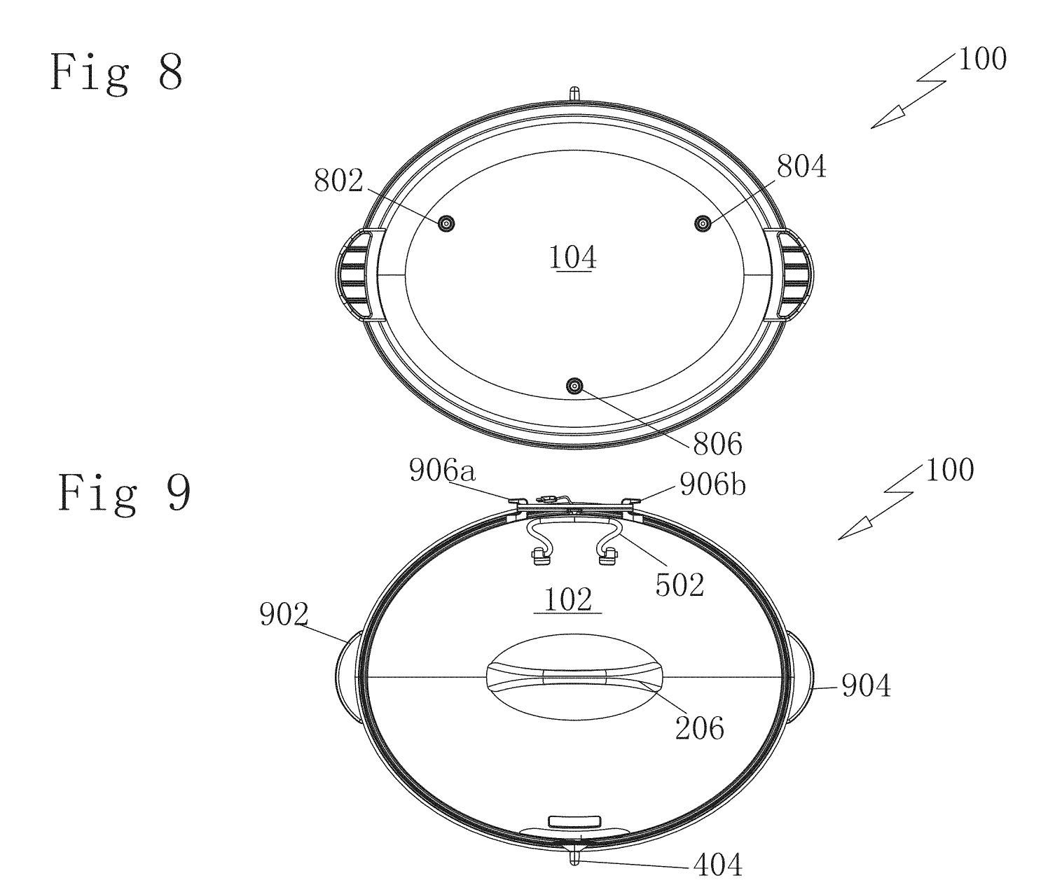

Referring to FIG. 8, a bottom view of the roasting oven 100 is shown. In various embodiments, the roasting oven 100 can include a plurality of feet, e.g., feet 802, 804, and/or 806. The feet 802, 804, and/or 806 can raise the roasting oven 100 a small distance above a support surface (e.g., a kitchen counter), such that air is free to circulate under the roasting oven 100. The roasting oven 100 can therefore rest on a variety of support surfaces without the risk of burning or damaging those support surfaces.

FIG. 9 shows a top view of the roasting oven 100. As described above, the roasting oven 100 can include the dome lid 102 and the handle 206. The roasting oven 100 can further include a plurality of side handles 902 and 904, which can be coupled to the base pan 104 and/or the dome lid 102 for lifting and/or moving all or a portion of the roasting oven 100. In addition, as shown, the fixed leg 504 can comprise a two part or two-piece support structure, comprising two members, 906a and 906b, each member 906a and 906b separated by a distance along and external perimeter of the dome lid 102. Such a spacing can lend added stability to the dome lid 102 when it is situated in a vertical or standing position.

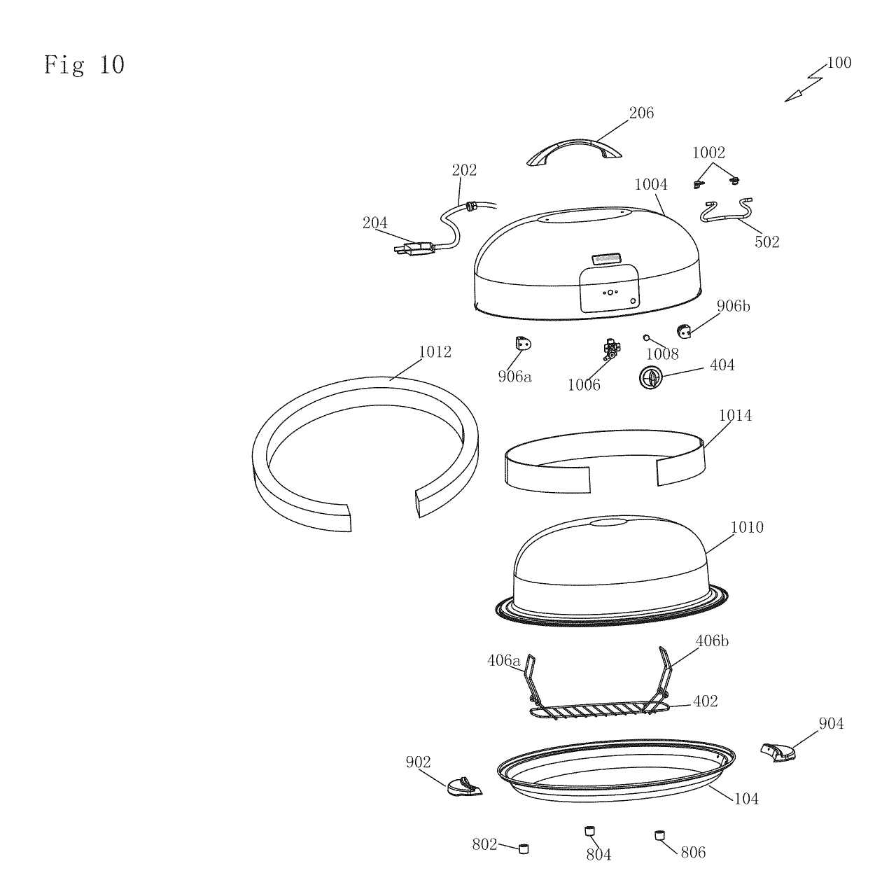

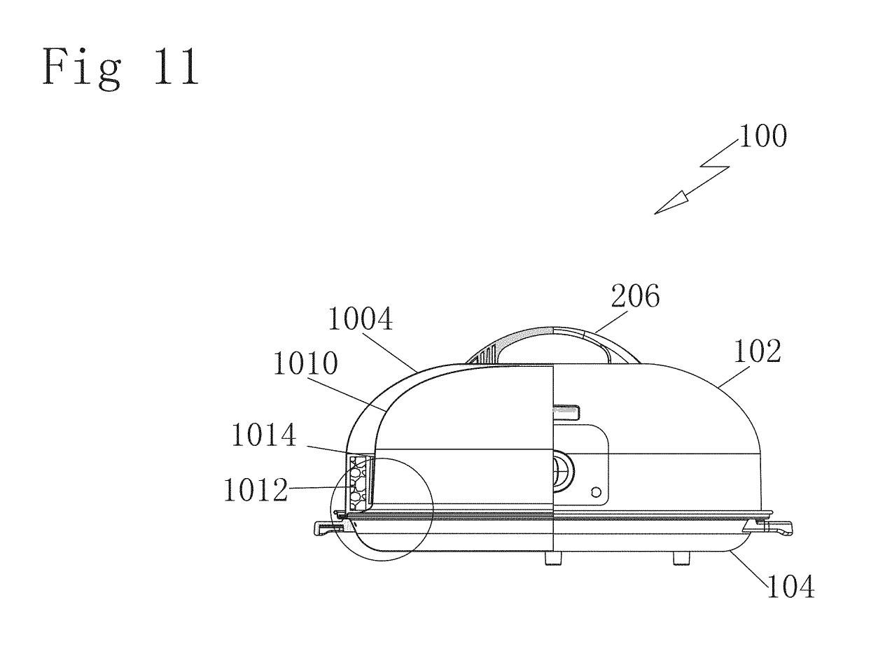

FIG. 10 shows an exploded view of the roasting oven 100. From the top down, the roasting oven 100 can comprise the handle 206, the power cable 202 and plug connector 204, one or more mounting brackets 1002, the fold out leg 502, an outer wall lid 1004, the fixed leg 504 (comprising members 906a and 906b), the temperature controlling component 404 (comprising a temperature control 1006 and a temperature control knob 1008), an insulating material 1012, a heating element 1014, an inner wall lid 1010, the rack 402 (including the lifting handles 406a and 406b), the base pan 104, the side handles 902 and 904, and the feet 802, 804, and 806. As described herein, the temperature control 1006 can comprise a thermostat or thermocouple. An operator of the roasting oven 100 can adjust the temperature (or other cooking setting, such as brownness or doneness) using the temperature control knob 1008.

In addition, as shown, the heating element 1014 can generally extend within the dome lid 102 from a first edge of the dome lid 102 to a second edge of the dome lid 102, such that the heating element 1014 extends along an entire (or substantially an entire) perimeter of the dome lid 102. The heating element 1014 is therefore, in various embodiments, radially disposed about all or a portion of the dome lid 102. However, in various embodiments, the heating element 1014 can extend within any portion of the dome lid 102 that is less than the entire perimeter of the dome lid 102. Moreover, as shown, the heating element 1014 can extend within the dome lid 102 (i.e., between an exterior surface of the inner wall lid 1010 and an interior surface of the outer wall lid 1004) as a “belt” or “heating belt” that extends radially within the dome lid 102 and to a predetermined elevation or height above the base of the dome lid 102. In other words, the heating element 1014 can comprise a belt or strip disposed within the dome lid 102 between the inner wall lid 1010 and the outer wall lid 1004. The heating element 1014 can further extend from a base of the dome lid 102 to a predetermined height above the base of the dome lid 102, such that the heating element is not disposed in a top portion of the dome lid 102.

As a result of the location of the heating element 1014 within the dome lid 102, the roasting oven 100 can apply indirect heat to the food product (including a top surface of the food product), so that the food product is uniformly browned, but not scorched by the heating element 1014. The heat energy generated by the heating element 1014 can, rather, be evenly (or substantially evenly) dispersed between the outer wall lid 1004 and the inner wall lid 1010. Therefore, as the heat generated by the heating element 1014 is contained and circulated within the dome lid 102, the heat can radiate more uniformly and with less intensity toward the food product, resulting in a uniformly browned, but not scorched, food product.

The heating element 1014 can comprise any suitable heating element, such as, for example, an electric heating element. An electric heating element can comprise a metallic structure having a resistance to electric current that generates heat energy when the electric current is passed through the electric heating element. The electric current can be supplied by the power cable 202, which can draw electric current from an electrical wall outlet as described above.

Moreover, although the heating element 1014 can be situated radially as a “belt” within the dome lid 102, the dome lid 102 can store substantial heat energy. Thus, as heat rises away from the heating element 1014, much of the heat can be trapped internally within the structure of the dome lid 102 itself. As a result, the dome lid 102 can radiate stored heat energy by way of a convective (air circulating) process towards the top and over outer surfaces of the enclosed food product. The food product can therefore brown uniformly within the roasting oven 100, notwithstanding the absence of a heating element directly overtop the food product.

FIG. 11 shows a partial cross-section of the roasting oven 100, in which the insulating material 1012 is disposed within the dome lid 102. More particularly, as shown, the portion of the heating element 1014 that faces the outer wall lid 1004 can be separated from the outer wall lid 1004 by the insulating material 1012, while the portion of the heating element 1014 that faces the inner wall lid 1010 can do so without an intervening layer of insulating material. Thus, some of the heat generated by the heating element 1014 can be allowed to escape through the inner wall lid 1010. This can help to dissipate some of the heat generated by the heating element 1014 into the heating chamber of the roasting oven 100.

The heating element 1014 may also include a heating belt. By way of example and not of limitation, the roasting oven 100 can include the insulating material 1012, which can be radially disposed about the heating element 1014 and positioned within the outer wall lid 1004, such that a top or upper portion of the dome lid 102 does not include the insulating material 1012. Moreover, as described herein, the heating element 1014 as well as the insulating material 1012 can extend substantially radially within the dome lid 102. In other words, the heating element 1014 and insulating material 1012 can extend about a perimeter (or substantially about a perimeter) of the dome lid 102 and within the dome lid 102 between the inner wall lid 1010 and the outer wall lid 1004. The heating element 1014 and/or insulating material 1012 can further extend from a base of the dome lid 102 to a predetermined height above the base of the dome lid 102.

In another illustrative heating belt embodiment, the insulating material 1012 can extend from the base to the top of the dome lid 102. Thus, the insulating material 1012 is disposed between the inner wall lid 1010 and the outer wall lid 1004. Also, the heating element 1014 is separated from contact with the outer wall lid 1004 by the insulating material 1012.

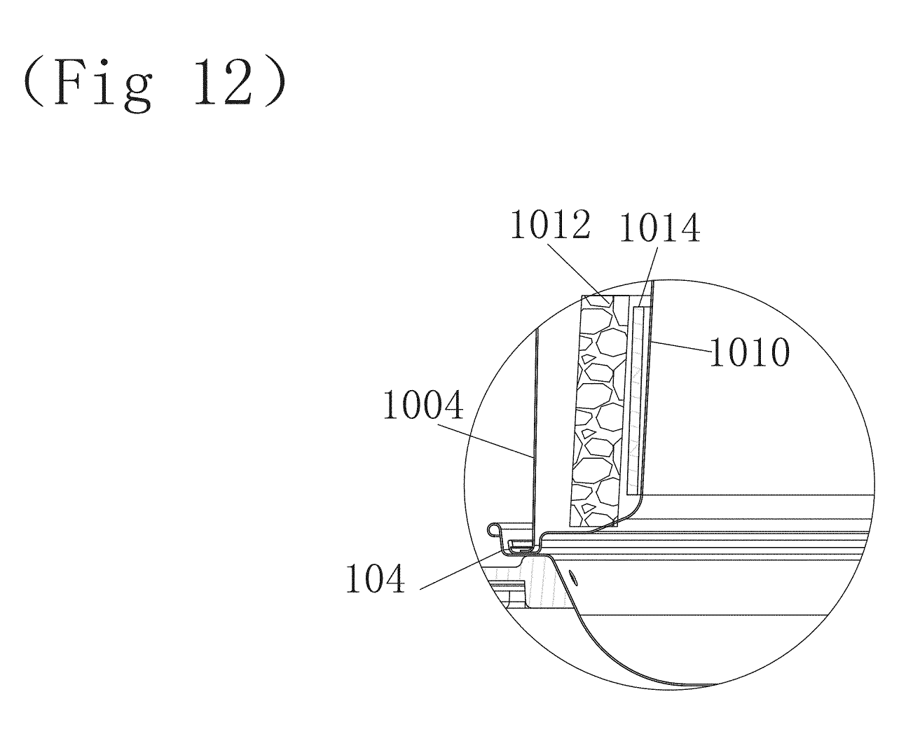

FIG. 12 shows a cutout view of the inner wall lid 1010 and outer wall lid 1004 of the dome lid 102. As shown, the inner wall lid 1010 can be joined to the outer wall lid 1004 at a base of the double walled dome lid 102 to form a chamber within which the heating element 1014 can be disposed. The insulating material 1012 can be disposed within the chamber formed between the outer wall lid 1004 and the inner wall lid 1010. The inner wall lid 1010 can be joined to the outer wall lid 1004 with a tab to seal the inner wall lid 1010 to the outer wall lid 1004. Additionally, the inner wall lid 1010 can be joined to the outer wall lid 1004 by welding, by pressure, by one or more rivets or bolts, by a heat bonding technique, by way of a heat-resistant adhesive, and the like.

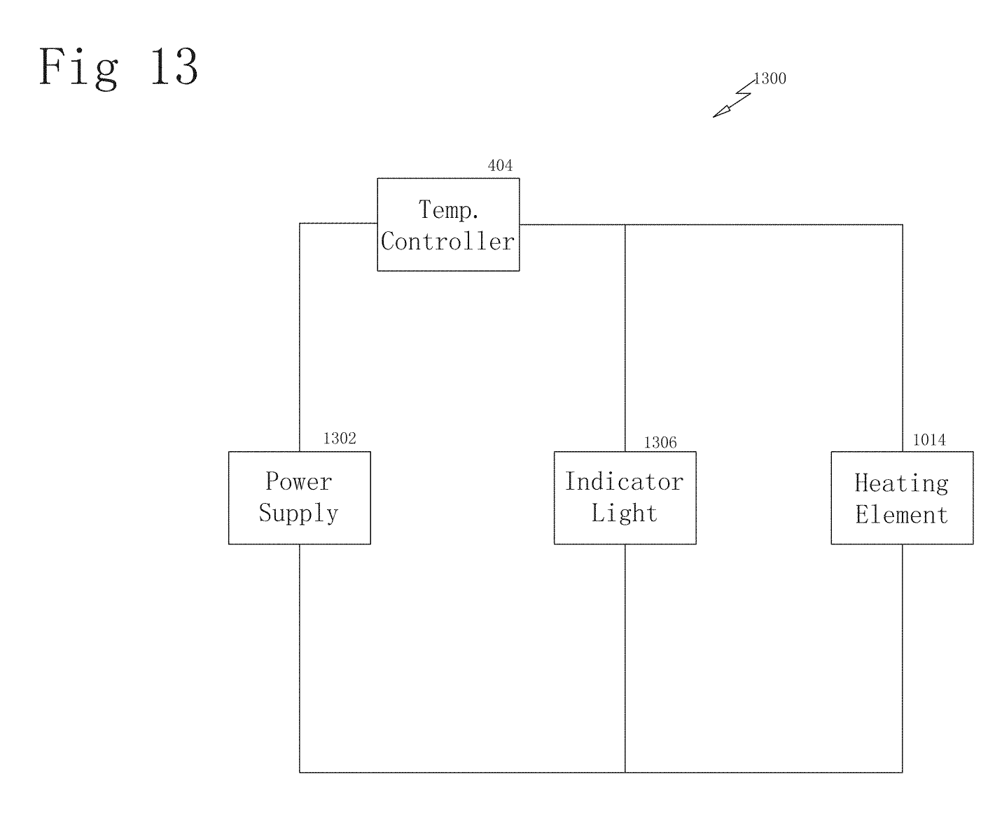

With reference to FIG. 13, an electrical circuit diagram 1300 of the roasting oven 100 is shown. In various embodiments, the roasting oven 100 can comprise a power supply 1302, the temperature controlling component 404, an indicator light 1306, and/or the heating element 1014. The power supply 1302 can be coupled, as described herein, to a wall outlet by way of the power cable 202. The power supply 1302 can supply power to the temperature controlling component 404, the indicator light 1306, and the heating element 1014. In various embodiments, and during operation, an operator of the roasting oven 100 can adjust the temperature controlling component 404 (e.g., by way of the knob 1008) to adjust the operating temperature of the roasting oven 100. The indicator light 1306 can be illuminated in response to a cooking input, during operation, during a preheating stage, and the like. The heating element 1014 can supply heat to the roasting oven 100 based upon the cooking input and in response to a temperature detected or measured by a thermostat or thermocouple of the temperature controlling component 404. More particularly, the temperature controlling component 404 can comprise, in various embodiments a rheostat or potentiometer, which can be adjusted in response to a cooking input corresponding to a position of the knob 1008. As the cooking input is increased or decreased, the power supplied to the heating element 1014 can be adjusted by the temperature controlling component 404, so that the heating element 1014 generates more or less heat. The power supplied to the heating element 1014 can further be adjusted (e.g., increased or decreased) based upon a temperature measurement.

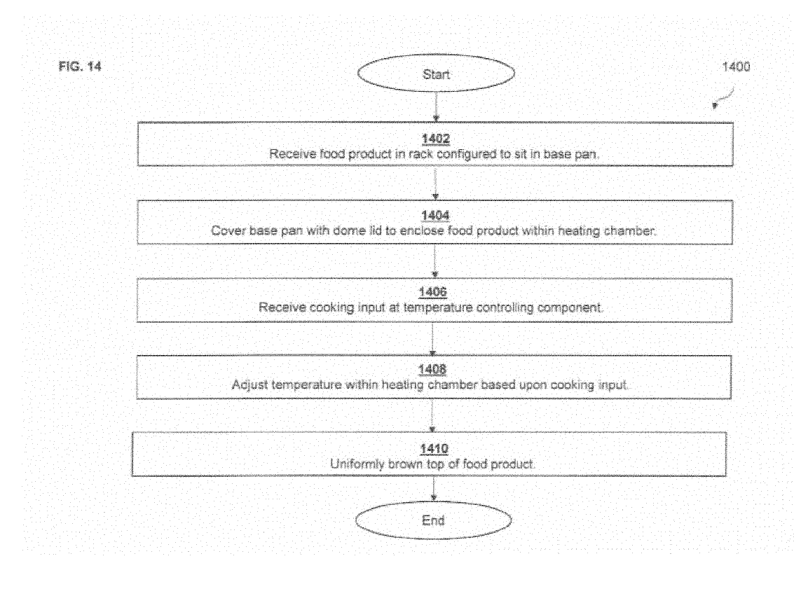

Referring now to FIG. 14, a process 1400 for cooking a food product with a roasting oven 100 is shown. In various embodiments, the process 1400 can comprise receiving a food product in a tray or rack 402 that is configured to sit in the (shallow) base pan 104 (step 1402). The base pan 104 can be covered by the dome lid 102, and the food product can be enclosed within the heating chamber defined between the base pan 104 and the dome lid 102 (step 1404). A cooking input (e.g., a cooking temperature, a desired doneness, a degree of browning, etc.) can be input and received by the temperature controlling component 404 (step 1406). The temperature controlling component 404 can include the heating element 1014, and the temperature controlling component 404 can adjust the heat output by the heating element 1014 based upon the cooking input (step 1408). Thus, the roasting oven 100 can cook and/or brown a food product to a desired and/or selected temperature, doneness, degree of browning, etc. As described herein, the food product (e.g., the top of the food product) may further be uniformly browned by the roasting oven 100 (step 1410).

The roasting oven 100 disclosed herein can therefore cook as well as uniformly brown a food product. More particularly, the outer surfaces (including a top surface, such as a turkey breast) of a food product can be uniformly browned by the roasting oven 100, because the heating element 1014 of the roaster oven 100 is disposed within the dome lid 102, such that heat radiates away from the lid and down over the food product. The heating element 1014 is further enclosed within the dome lid 102, so that heat is not directly applied to the food product, but indirectly, as it circulates within the dome lid 102. Moreover, because the dome lid 102 is large and extends over and around a large portion of the food product, the roasting oven 100 is capable of both browning a top surface (and side and/or other surfaces) of the food product as well as cooking the food product to a desired temperature or doneness.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

1. A roasting oven comprising:
a double walled dome lid having a dome lid height, the double walled dome lid includes a domed inner wall lid and a domed outer wall lid, wherein the domed inner wall lid and domed outer wall lid are joined at a base of the double walled dome lid;
a base pan that interfaces with the base of the double walled dome lit the base pan having a base pan height of approximately 1.5″ deep;
the base pan not having a heating element;
wherein the dome lid height is at least four times greater than the base pan height;
a temperature controlling component disposed in the double walled dome lid, wherein the temperature controlling component includes a heating element that is electrically coupled to the temperature controlling component, wherein the heating element is radially disposed about an exterior surface of the domed inner wall lid, and wherein the heating element is positioned within the domed outer wall lid.

2. The roasting oven of claim 1, wherein the double walled dome lid includes a fixed leg that enables the double walled dome lid to stand when the double walled dome lid is vertically positioned.

3. The roasting oven of claim 1, wherein the double walled dome lid includes a fold out leg that enables the double walled dome lid to stand when the double walled dome lid is vertically positioned.

4. The roasting oven of claim 1, wherein the double walled dome lid includes a fixed leg and a fold-out leg that enables the double walled dome lid to stand when the double walled dome lid is vertically positioned.

5. The roasting oven of claim 1 wherein the heating element includes a heating belt and further comprising an insulating material radially disposed about said heating element and positioned within the outer wall lid, wherein a top of the double walled dome does not include insulating materials.

6. The roasting oven of claim 1 further wherein the heating element includes a heating belt and comprising an insulating material that is disposed about the perimeter of the domed inner wall lid and between the domed inner wall lid and the domed outer wall lid, wherein the domed inner and the domed outer wall lid are substantially perpendicular to the base pan.

7. The roasting oven of claim 1 wherein the temperature controlling component includes a thermostat.

8. The roasting oven of claim 1 wherein the temperature controlling component includes a thermocouple.

9. A roasting oven system comprising:
a double walled dome lid having a dome lid height, the double walled dome lid includes a domed wall lid and an outer wall lid, wherein the domed inner wall lid and outer wall lid are joined at a base of the double walled dome lid;
a base pan that interfaces with the base of the double walled dome lid, which forms a chamber;
the base pan having a base pan height of approximately 1.5″ deep;
the base pan not having a heating element;
wherein the dome lid height is at least four times greater than the base pan height;
a tray configured to sit on the base pan and receive a food product;
a temperature controlling component disposed in the double walled dome lid, wherein the temperature controlling component includes a heating element that is electrically coupled to the temperature controlling component, the heating element radially disposed about an exterior surface of the domed inner wall lid and the heating element positioned within the outer wall lid; and
the temperature controlling component configured to receive a cooking input that causes the heating element to heat the chamber so that the food product is uniformly browned.

10. The roasting oven system of claim 9, wherein the double walled dome lid includes a fixed leg and a fold-out leg that enables the double walled dome lid to stand when the double walled dome lid is vertically positioned.

11. The roasting oven system of claim 9 wherein the heating element includes a heating belt and further comprising an insulating material radially disposed about said heating element and positioned within the outer wall lid, wherein a top of the double walled dome does not include insulating materials.

12. The roasting oven system of claim 9 wherein the heating element includes a heating belt and further comprising an insulating material that is disposed between the domed inner wall lid and the outer wall lid.

13. The roasting oven system of claim 9 wherein the temperature controlling component includes a thermostat.

14. The roasting oven system of claim 9 wherein the temperature controlling component includes a thermocouple.

15. A method for cooking with a roasting oven, the method comprising,
receiving a food product on a base pan;
covering the base pan with a double walled dome lid that having a dome lid height, the double walled dome lid includes a domed inner wall lid and an outer wall lid, wherein the domed inner wall lid and outer wall lid are joined at a base of the double walled dome lid, in which the base interfaces with the base pan to form a chamber;
the base pan having a base pan height of approximately 1.5″ deep;
the base pan not having a heating element;
wherein the dome lid height is at least four times greater than the base pan height;
receiving a cooking input at a temperature controlling component that is disposed within the double walled dome lid, the temperature controlling component includes a heating element that is electrically coupled to the temperature controlling component, and the heating element is radially disposed about an exterior surface of the domed inner wall lid and the heating element positioned within the outer wall lid; and
heating the chamber with the heating element so that the food product is uniformly browned.

16. The method for cooking with the roasting oven of claim 15, wherein the double walled dome lid includes a fixed leg and a fold-out leg that enables the double walled dome lid to stand when the double walled dome lid is vertically positioned.

17. The method for cooking with the roasting oven of claim 15 wherein the heating element includes a heating belt and an insulating material is radially disposed about said heating element and positioned within the outer wall lid, and wherein a top of the double walled dome does not include insulating materials.

18. The method for cooking with the roasting oven of claim 15 wherein the heating element includes a heating belt and an insulating material is disposed between the domed inner wall lid and the outer wall lid.

19. The method for cooking with the roasting oven of claim 15, wherein the temperature controlling component includes a thermostat.

20. The method for cooking with the roasting oven of claim 15, wherein the temperature controlling component includes a thermocouple.
